(19) United States
(12) Patent Application Publication
(10) Pub. No.: US 2007/0109728 A1
(43) Pub. Date: May 17, 2007

(54) ELECTRONIC DEVICE WITH FIXING DEVICES

(75) Inventor: Jen-Yu Liang, Tu-Cheng,Taipei Hsien (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD, Taipei Hsien (TW)

(21) Appl. No.: 11/308,938

(22) Filed: May 29, 2006

(30) Foreign Application Priority Data
Nov. 17, 2005 (CN) 200520067937.7

(51) Int. Cl. H02B 1/00

(52) U.S. Cl. 361/600

(57) ABSTRACT

An electronic device (10) includes a circuit board (30) and a panel (20). The circuit board includes at least one receiving portion (36), a first surface (32), and a second surface (34) opposite to the first surface. The panel includes a main portion (22) and at least one fixing member (24) extending from the main portion. The at least one fixing member includes a protruding portion (245) and a guiding portion (246). Whereby, in assembly, the guiding portion guides the protruding portion to be received in the at least one receiving portion so as to attach the panel to the circuit board.

### FIELD OF THE INVENTION

The invention relates to electronic devices, and particularly to an electronic device with a fixing device for attaching a panel to a circuit board.

### DESCRIPTION OF RELATED ART

As electronic devices have improved rapidly, they have included more and more functions. Accordingly, more and more controlling buttons are needed on a front bezel of each electronic device to facilitate the customers operating the electronic device. Meanwhile, the controlling buttons must be connected to a circuit board. Generally, the front bezel is mounted to the circuit board via screws.

Referring to FIG. 4, a conventional electronic device 50 is shown. The electronic device 50 comprises a circuit board 52 defining a pair of receiving portions 520 at an end thereof, and a front panel 54 defining a pair of threaded-holes 520 corresponding to the receiving portions 520. In assembly, two screws 60 are mounted in the threaded-holes 520 via the receiving portions 520 for securing the circuit board 52 and the front panel 54 together. However, the method of the assembly of the circuit board 52 and the front panel 54 is unduly cumbersome and time consuming.

Therefore, a heretofore unaddressed need exists in the industry to overcome the aforementioned deficiencies and inadequacies.

### SUMMARY OF THE INVENTION

In an exemplary embodiment, an electronic device includes a circuit board and a panel. The circuit board includes at least one receiving portion, a first surface and a second surface opposite to the first surface. The panel includes a main portion and at least one fixing member extending from the main portion. The at least one fixing member includes a protruding portion and a guiding portion. Whereby, in assembly, the guiding portion guides the protruding portion to be received in the at least one receiving portion so as to attach the panel to the circuit board.

Other advantages and novel features will become more apparent from the following detailed description of preferred embodiments when taken in conjunction with the accompanying drawings, in which:

### BRIEF DESCRIPTION OF THE DRAWINGS

FIG. 1 is an exploded, perspective view of an electronic device in accordance with an exemplary embodiment of the invention, the electronic device including a panel and a circuit board;

FIG. 2 is a partly, cut-away, assembled view of FIG. 1;

FIG. 3 is an enlarged view of circle portion III of FIG. 2; and

FIG. 4 is an exploded, perspective view of a conventional electronic device.

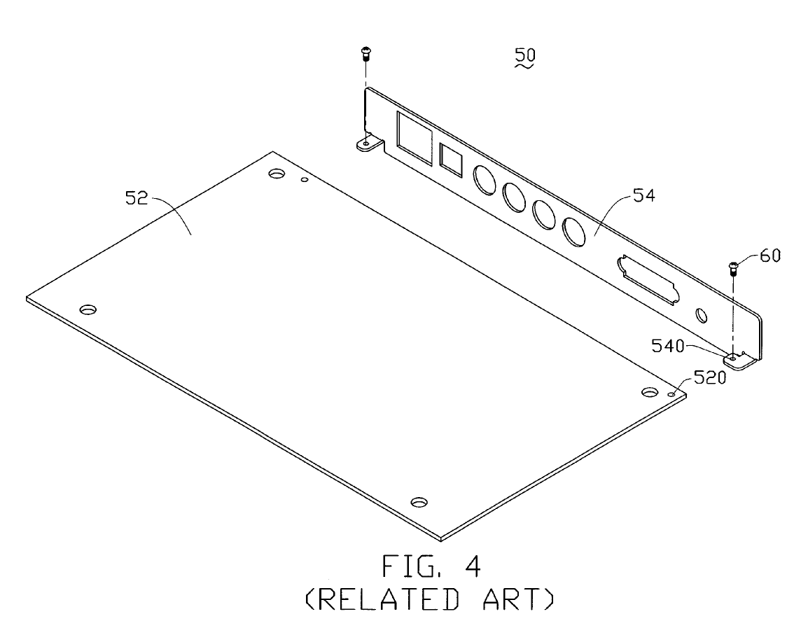

### DETAILED DESCRIPTION OF THE INVENTION

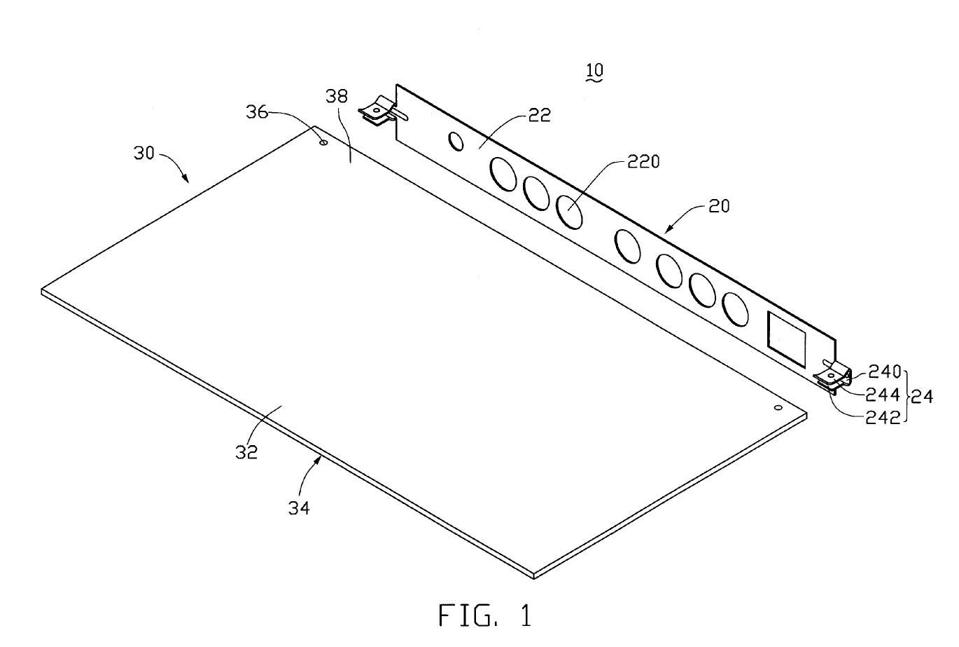

Referring to FIG. 1, an exemplary electronic device 10 in accordance with the invention comprises a panel 20 and a circuit assembly like a circuit board 30.

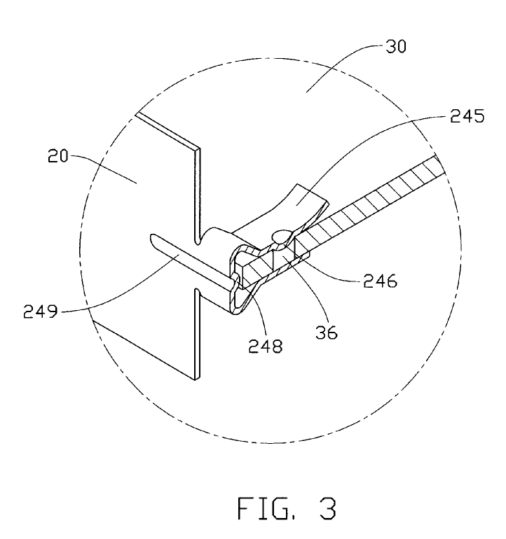

Referring also to FIG. 3, the panel 20 comprises a main portion 22, and a pair of fixing members 24 extending from opposite ends of the main portion 22 respectively. A plurality of apertures 220 is defined in the main portion 22, for receiving buttons or connectors (not shown). Each fixing member 24 comprises a main body 240, a first clipping portion 242, and a second clipping portion 244 opposite to the first clipping portion 242. The first clipping portion 242 and the second clipping portion 244 horizontally extend from opposite sides of the main body 240 respectively. A distance between the first clipping portion 242 and the second clipping portion 244 is generally equal to a thickness of the circuit board 30. A length of the second clipping portion 244 is slightly greater than that of the first clipping portion 242. The second clipping portion 244 comprises a protruding portion 246 generally formed in a middle thereof protruding toward the first clipping portion 242, and a guiding portion 245 formed at an end thereof and bent back relative to the first clipping portion 242. The guiding portion 245 is used for guiding a movement of the protruding portion 246. The main body 240 extends from a middle of an end of the main portion 22 of the panel 20. A protrusion 248 is stamped from a middle of the main body 240 projecting toward the circuit board 30, thereby a groove 249 is defined in the main body 240 corresponding to the protrusion 248. The protrusions 248 are used for reinforcing the first clipping portion 242 and the second clipping portion 244.

The circuit board 30 comprises a first surface 32, a second surface 34 opposite to the first surface 32, and a pair of receiving portions 36 corresponding to the fixing members 24 of the panel 20. Each receiving portion 36 extends through the first surface 32 and the second surface 34. The fixing members 24 of the panel 20 and the receiving portions 36 of the circuit board 30 cooperatively are designated as a fixing device for attaching the panel 20 to the circuit board 30. As an alternative embodiment, the receiving portion 36 can be a recess defined in the first surface 32.

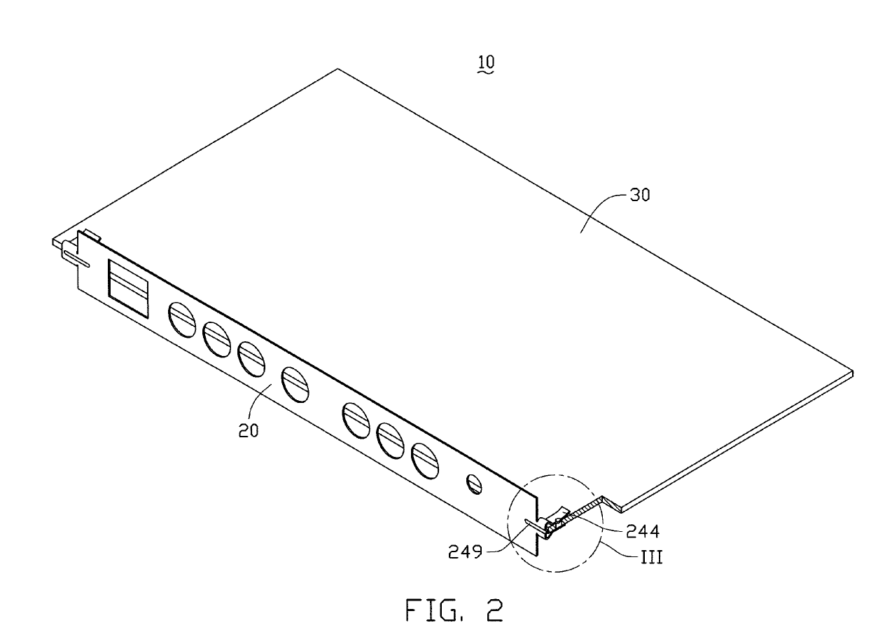

Referring to FIGS. 1-3, in assembly, the first clipping portion 242 and the second clipping portion 244 of the panel 20 clamp the end 38 of the circuit board 30. The panel 20 is pushed toward the circuit board 30 with the protruding portion 246 being received in the receiving portion 36 by virtue of the guidance of the guiding portions 245. Thus, the panel 20 is stably mounted to the circuit board 30. In disassembly, the protruding portion 246 is removed from the receiving portion 36 via pressing the first clipping portion 242 and the second clipping portion 244, so that the panel 20 is disengaged from the circuit board 30. Therefore, assembly and disassembly of the electronic device is simple.

Because the guiding portion 245 guides the movement of the protruding portion 246, the protruding portion 246 is easily received in the receiving portion 36. Accordingly, the panel 20 is easily attached to the circuit board 30.

To assemble or disassemble the electronic device using the fixing device is simple for a user. In mass manufacture, a process of assembly (or disassembly) does not necessarily require a professional operator, and thus production costs may be reduced.

As an alternative embodiment, the main body 22 of the panel 20 comprises a fixing member 24 positioned in a middle thereof. Simultaneously, the circuit board 30 defines a receiving portion 36 corresponding to the fixing member 24.

As another alternative embodiment, the first clipping portion 242 also comprises a protruding portion 246 and a guiding portion 245. Correspondingly, the circuit board defines a pair of receiving portions 36 extending through the first surface 32 and the second surface 34, or comprises two pairs of receiving portions defined in the first surface and the second surface symmetrically.

While exemplary embodiments have been described above, it should be understood that they have been presented by way of example only and not by way of limitation. Thus the breadth and scope of the present invention should not be limited by the above-described exemplary embodiments, but should be defined only in accordance with the following claims and their equivalents.

What is claimed is:

1. An electronic device comprising:
a circuit board comprising at least one receiving portion, a first surface and a second surface opposite to the first surface; and
a panel comprising a main portion and at least one fixing member extending from the main portion, the at least one fixing member comprising a protruding portion and a guiding portion;
Whereby, in assembly, the guiding portion guides the protruding portion to be received in the receiving portion so as to attach the panel to the circuit board.

2. The electronic device as claimed in claim 1, wherein the number of the at least one fixing member is two.

3. The electronic device as claimed in claim 2, wherein each of the fixing member comprises a main body extending from an end of the main portion, a first clipping portion, and a second clipping portion opposite to the first clipping portion.

4. The electronic device as claimed in claim 3, wherein a length of the first clipping portion is slightly less than that of the second clipping portion.

5. The electronic device as claimed in claim 3, wherein a distance between the first clipping portion and the second clipping portion is generally equal to a thickness of the circuit board.

6. The electronic device as claimed in claim 3, wherein the guiding portion is formed at a distal end of the second clipping portion bent back relative to the first clipping portion.

7. The electronic device as claimed in claim 3, wherein the protruding portion is formed in a middle of the second clipping portion protruding toward the first clipping portion.

8. The electronic device as claimed in claim 3, wherein the number of the protruding portion is two, the protruding portions are formed in the first clipping portion and the second clipping portion respectively.

9. The electronic device as claimed in claim 3, wherein a protruding portion is stamped from a middle of the main body for reinforcing the first clipping portion and the second clipping portion.

10. The electronic device as claimed in claim 3, wherein the number of the guiding portion is two, the guiding portions are formed at distal ends of the first clipping portion and the second clipping portion respectively and bent outwardly.

11. The electronic device as claimed in claim 1, wherein the number of the at least one receiving portion is two, each of the receiving portions extends through the first surface and the second surface.

12. The electronic device as claimed in claim 1, wherein the number of the at least one receiving portion is two, each of the receiving portions defined in the first surface.

13. The electronic device as claimed in claim 1, wherein the number of the at least one receiving portion is four, a pair of the receiving portions defined in the first surface and a pair of the receiving portions defined in the second surface.

14. A fixing device for securing a panel on a circuit board, the fixing device comprising:
at least one fixing member connecting with the panel, the at least one fixing member comprising a protruding portion and a guiding portion; and
at least one receiving portion defined in the circuit board;
whereby, in assembly, the guiding portion guides the protruding portion to be received in the receiving portion so as to attach the panel to the circuit board.

15. The fixing device as claimed in claim 14, wherein the at least one fixing member comprises a main body extending from the panel, a first clipping portion and a second clipping portion opposite to the first clipping portion.

16. The fixing device as claimed in claim 15, wherein a length of the first clipping portion is slightly less than that of the second clipping portion.

17. The fixing device as claimed in claim 15, wherein the number of the protruding portion is two, the protruding portions are formed in the first clipping portion and the second clipping portion respectively.

18. The fixing device as claimed in claim 15, wherein the number of the guiding portion is two, the guiding portions are formed at distal ends of the first clipping portion and the second clipping portion respectively.

19. An electronic device comprising:
a circuit assembly removably installable in said electronic device, said circuit assembly defining a receiving portion close to an edge of said circuit assembly; and
a panel partially enclosing said electronic device and extending along said edge of said circuit assembly, and comprising a fixing member corresponding to said receiving portion of said circuit assembly, said fixing member comprising a first clipping portion extending along a first side of said circuit assembly neighboring said edge of said circuit assembly in order to abut against said first side, and a second clipping portion extending along a second side of said circuit assembly, opposing to said first side, neighboring said edge of said circuit assembly in order to abut against said second side, a protruding portion selectively formed on one of said first and second clipping portions to reachably engagable with said receiving portion for better fixation between said panel and said circuit assembly.

20. The electronic device as claimed in claim 19, wherein said one of said first and second clipping portions comprises a guiding portion formed at a distal end of said one of said first and second clipping portions to guide assembling movement of said circuit assembly toward said panel, and said guiding portion makes said one of said first and second clipping portions extending longer than the other of said first and second clipping portions away from said panel.
